(19) United States
(12) Patent Application Publication
(10) Pub. No.: US 2006/0236017 A1
(43) Pub. Date: Oct. 19, 2006

(54) Synchronizing primary and secondary fabric managers in a switch fabric

(76) Inventors: Mo Rooholamini, Gilbert, AZ (US); Ward McQueen, Chandler, AZ (US); Randeep Kapoor, Gilbert, AZ (US)

Correspondence Address: FISH & RICHARDSON, PC, P.O. BOX 1022, MINNEAPOLIS, MN, 55440-1022, US

(21) Appl. No.: 11/108,988

(22) Filed: Apr. 18, 2005

(51) Int. Cl. G06F 13/00

(52) U.S. Cl. 710/316

(57) ABSTRACT

The present disclosure includes systems and techniques relating to interconnecting components within computing and network devices. In general, in one implementation, the technique includes: sending a message from a primary fabric manager to an initiating secondary fabric manager in a switch fabric; obtaining, at the secondary fabric manager and in response to the message, an initial fabric topology; and synchronizing fabric management information between the primary fabric manager and the secondary fabric manager. The synchronizing may include synchronizing multicast information and peer-to-peer connections information and may include sending incremental update messages. Additionally, the technique may include detecting failure of the primary fabric manager based on receipt of heartbeat messages and a timeout period determined according to a diameter of the switch fabric, a per-link message delay and a path-repair delay.

### BACKGROUND

The present application describes systems and techniques relating to interconnecting components within computing and network devices.

Traditional data processing devices have used buses to interconnect internal components. Typically a shared-bus architecture provides a common bus over which internal system components can communicate (e.g., the Peripheral Component Interconnect (PCI) bus). Such shared-buses typically allow multiple components (e.g., input/output (I/O) ports of components within the device) to be plugged into the bus as needed, and some type of arbitration process is used to handle contention for the shared bus.

Other system interconnect architectures include shared memory designs and point-to-point switching fabrics. In a shared memory architecture, data is placed in the shared memory when it arrives at a port within the device, and this data is then moved to an appropriate output port within the device. In a switch fabric design, multiple input ports and multiple output ports within a device are connected by a matrix of switching points that provide any-to-any, point-to-point links among the ports. Links may be set up on-the-fly for the duration of a data exchange between components within the computing device, and multiple links may be active at once.

PCI Express is a serialized I/O interconnect standard developed to meet the increasing bandwidth needs of data processing machines. PCI Express was designed to be fully compatible with the widely used PCI local bus standard. Various extensions to the PCI standard have been developed to support higher bandwidths and faster clock speeds. With its high-speed and scalable serial architecture, PCI Express may be an attractive option for use with or as a possible replacement for PCI in computer systems. The PCI Express architecture is described in the PCI Express Base Specification, Revision 1.1, which is available through the PCI-SIG (PCI-Special Interest Group) (www-pcisig-com), published Mar. 28, 2005.

Advanced Switching Interconnect (ASI) is a switch fabric technology, which is an extension to the PCI Express architecture. ASI utilizes a packet-based transaction layer protocol that operates over the PCI Express physical and data link layers. The ASI architecture provides a number of features common to multi-host, peer-to-peer communication devices such as blade servers, clusters, storage arrays, telecom routers, and switches. These features include support for flexible topologies, packet routing, congestion management (e.g., credit-based flow control), fabric redundancy, and fail-over mechanisms. The ASI architecture is described in the Advanced Switching Core Architecture Specification, Revision 1.0 (the “ASI Specification”) (December 2003), which is available through the ASI-SIG (Advanced Switching Interconnect SIG) (www-asi-sig-org).

### DRAWING DESCRIPTIONS

FIG. 1 is a block diagram showing a system with a data processing machine including a switch fabric and a fabric management component.

FIG. 2 shows the protocol stacks for the PCI Express and Advanced Switching Interconnect (ASI) architectures.

FIG. 3 shows an ASI transaction layer packet (TLP) format.

FIG. 4 shows an ASI path header format.

FIG. 5 is a flow chart showing an example process of initializing fabric management synchronization.

FIG. 6 is a flow chart showing an example process of failover in a fabric management system.

FIG. 7 is a flow chart showing an example process of maintaining fabric management synchronization.

FIG. 8 is a flow chart showing a process of initializing and maintaining fabric management synchronization.

FIG. 9 is a flow chart showing a process of failover in a fabric management system.

Details of one or more embodiments are set forth in the accompanying drawings and the description below. Other features and advantages may be apparent from the description and drawings, and from the claims.

### DETAILED DESCRIPTION

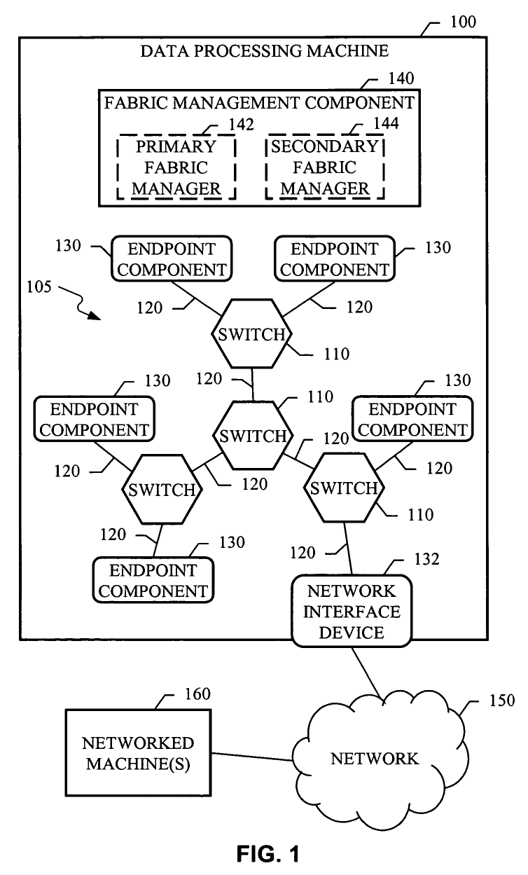

FIG. 1 is a block diagram showing a system with a data processing machine 100 including a switch fabric 105 and a fabric management component 140. The switch fabric 105 includes switches 110 and links 120 that provide pathways configured to transfer information among endpoint components 130 within the data processing machine 100.

The endpoints 130 reside on the edge of the switch fabric and represent data ingress and egress points for the switch fabric. The endpoints 130 may encapsulate and/or translate packets entering and exiting the switch fabric and may be viewed as bridges between the switch fabric and other interfaces. Moreover, the endpoints 130 may be various components within the data processing machine or interfaces to such components, such as integrated circuit chips, adapters, memories, or other electronic devices.

For example, a component attached to the switch fabric may include a network interface device 132. The network interface device 132 may be a network interface card (NIC) or an integrated network device (e.g., a network adapter built into a main circuit board, such as a motherboard, of the machine 100). In general, the network interface device 132 connects the machine 100 with a network 150, which may be a land-based computer network or a mobile device network, thus providing communications access to one or more networked machines 160.

The data processing machine 100 may be a computing device, a network device, or both. For example the machine 100 may be a mobile phone, a network router or switch, or a server system. The machine 100 may be a modular machine, including high-performance backplane interconnects and modular elements, such as a network server having interchangeable cards or blade servers. Moreover, the endpoint components 130 may itself be any computing device, such as a server.

The machine 100 includes a fabric management component 140, which is configured to cause a primary fabric manager 142 to trigger an initiating secondary fabric manager 144 to obtain an initial fabric topology, and further configured to synchronize fabric management information between the primary fabric manager 142 and the secondary fabric manager 144. The primary and secondary fabric managers 142, 144 may be subcomponents of the fabric management component 140, or the primary and secondary fabric managers 142, 144 may be separate components. For example, the primary and secondary fabric managers 142, 144 can be separate software products that run on two respective privileged devices in the switch fabric, or the primary and secondary fabric managers 142, 144 can be different functionality implemented within a single software product that runs on two privileged devices in the switch fabric.

The primary fabric manager 142 oversees the switch fabric. The secondary fabric manager 144 acts as a hot backup to the primary fabric manager 142 (although the secondary fabric manager 144 need not be dedicated to fabric management operations and may concurrently provide other functionality). Fabric management information, such as multicast information and peer-to-peer connections information, is synchronized between the primary fabric manager 142 and the secondary fabric manager 144. If the secondary fabric manager 144 determines that the primary fabric manager 142 has failed, fabric management operations failover to the secondary fabric manager 144, which continues running the switch fabric with minimal interruption, thus providing a high availability feature for the switch fabric.

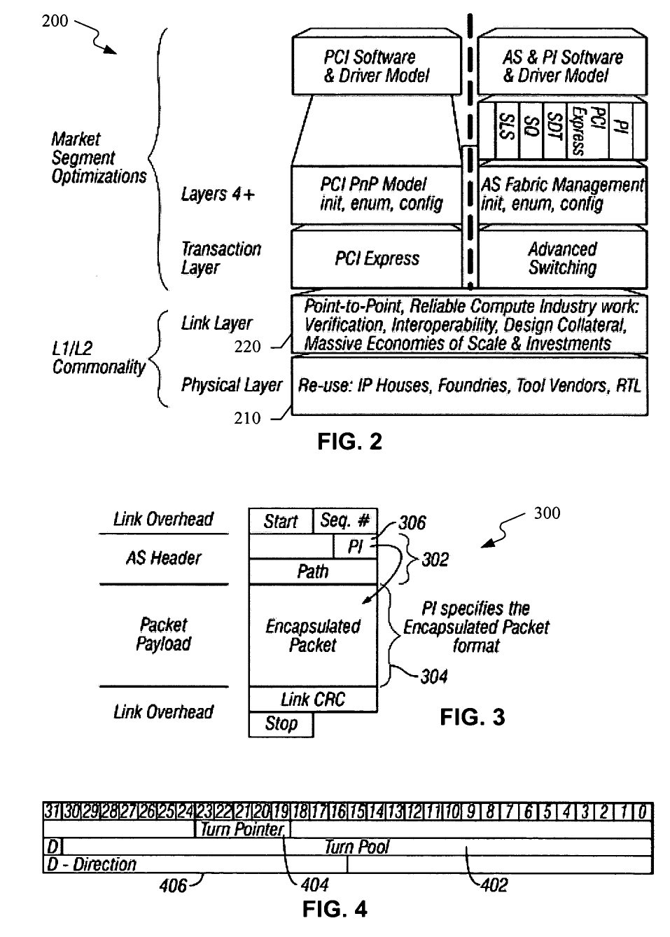

The switch fabric may conform to an Advanced Switching Interconnect (ASI) specification defined by an ASI Special Interest Group (SIG). FIG. 2 shows the protocol stacks 200 for the PCI Express and ASI architectures. As shown, ASI utilizes a packet-based transaction layer protocol that operates over the PCI Express physical and data link layers 210, 220.

ASI uses a path-defined routing methodology in which the source of a packet provides all information used by a switch (or switches) to route the packet to the desired destination. FIG. 3 shows an ASI transaction layer packet (TLP) format 300. The packet includes a path header 302 and an encapsulated packet payload 304. The ASI path header 302 contains the information used to route the packet through an ASI fabric (i.e., the path), and a field that specifies the Protocol Interface (PI) of the encapsulated packet. ASI switches use the information contained in the path header 302 to route packets and generally do not care about the contents of the encapsulated packet 304.

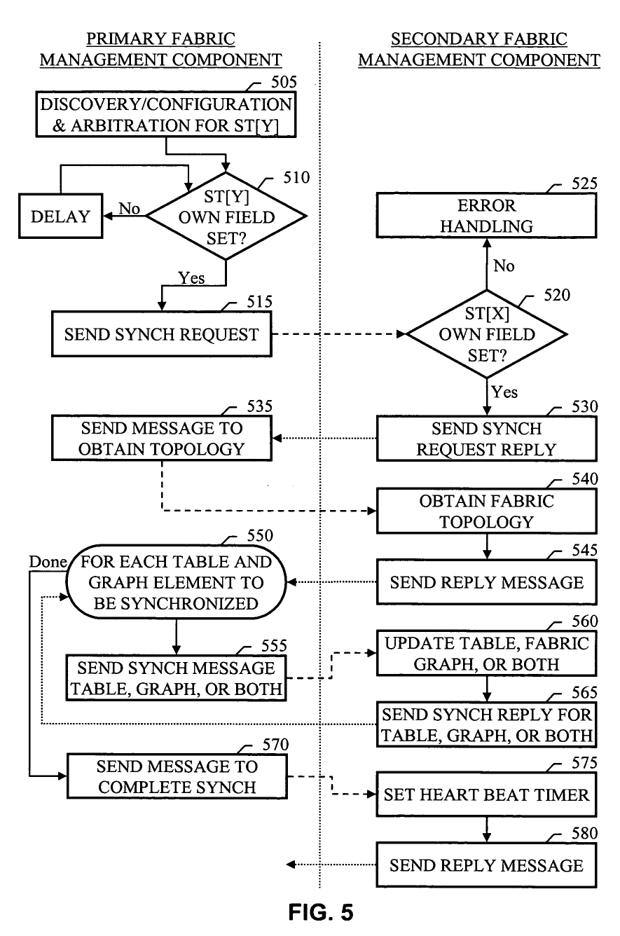

A path may be defined by the turn pool 402, turn pointer 404, and direction flag 406 in the path header, as shown in FIG. 4. A packet's turn pointer indicates the position of the switch's turn value within the turn pool. When a packet is received, the switch may extract the packet's turn value using the turn pointer, the direction flag, and the switch's turn value bit width. The extracted turn value for the switch may then be used to calculate the egress port.

The PI field 306 in the ASI path header 302 (FIG. 3) specifies the format of the encapsulated packet. The PI field is inserted by the endpoint that originates the ASI packet and is used by the endpoint that terminates the packet to correctly interpret the packet contents. The separation of routing information from the remainder of the packet enables an ASI fabric to tunnel packets of any protocol.

PIs represent fabric management and application-level interfaces to the switch fabric. Table 1 provides a list of PIs currently supported by the ASI Specification.

TABLE 1
ASI protocol interfaces

| PI number | Protocol Interface |
|---|---|
| 0 | Path Building |
| (0:0) | (Spanning Tree Generation) |
| (0:1-126) | (Multicast) |
| 1 | Congestion Management (Flow ID messaging) |
| 2 | Segmentation and Reassembly |
| 3 | Reserved for future ASI Fabric Management Interfaces |
| 4 | Device Management |
| 5 | Event Reporting |
| 6-7 | Reserved for future ASI Fabric Management Interfaces |
| 8-95 | ASI SIG ™ defined PIs |
| 96-126 | Vendor defined PIs |
| 127 | Invalid |

PIs 0-7 are reserved for various fabric management tasks, and PIs 8-126 are application-level interfaces. The protocol interfaces may be used to tunnel or encapsulate native PCI Express, as well various other protocols, e.g., Ethernet, Fibre Channel, ATM (Asynchronous Transfer Mode), InfiniBand®, and SLS (Simple Load Store). A feature of an ASI switch fabric is that a mixture of protocols may be simultaneously tunneled through a single, universal switch fabric, which can be used by next generation modular applications such as media gateways, broadband access routers, and blade servers.

The ASI architecture supports the implementation of an ASI Configuration Space in each ASI device in the network. The ASI Configuration Space is a storage area that includes fields to specify device characteristics as well as fields used to control the ASI device. The information is presented in the form of capability structures and other storage structures, such as tables and a set of registers. Table 2 provides a set of capability structures (ASI native capability structures) that are defined by the ASI Specification.

TABLE 2
ASI Native Capability Structures

| ASI Native Capability Structure | Endpoints | Switches |
|---|---|---|
| Baseline Device | R | R |
| Spanning Tree | R | R |
| Spanning Tree Election | O | N/A |
| Switch Spanning Tree | N/A | R |
| Device PI | O | O |
| Scratchpad | R | R |
| Doorbell | O | O |
| Multicast Routing Table | N/A | O |
| Semaphore | R | R |
| ASI Event | R | R |
| ASI Event Spooling | O | N/A |
| ASI Common Resource | O | N/A |
| Power Management | O | N/A |
| Virtual Channels | R w/OE | R w/OE |
| Configuration Space Permission | R | R |
| Endpoint Injection Rate Limit | O | N/A |
| Status Based Flow Control | O | O |
| Minimum Bandwidth Scheduler | N/A | O |
| Drop Packet | O | O |
| Statistics Counters | O | O |
| Transport Services | O | N/A |
| Integrated Devices | O | N/A |
| Path Input/Output (PIO) Translation | O | N/A |

Legend:
O = Optional normative
R = Required
R w/OE = Required with optional normative elements
N/A = Not applicable

The information stored in the ASI native capability structures may be accessed through PI-4 packets, which are used for device management.

In some implementations of a switched fabric, the ASI devices on the fabric may be restricted to read-only access of another ASI device's ASI native capability structures, with the exception of one or more ASI end nodes which have been elected as fabric managers. A fabric manager election process may be initiated by a variety of either hardware and/or software mechanisms to elect one or more fabric managers for the switched fabric network. A fabric manager is an ASI endpoint that in one sense owns all of the ASI devices, including itself, in the switch fabric. When both a primary fabric manager and a secondary fabric manager are elected, the secondary fabric manager may declare ownership of the ASI devices in the network upon a failure of the primary fabric manager.

Once a fabric manager declares ownership, that fabric manager has privileged access to it's ASI devices' ASI native capability structures. In other words, the fabric manager has read and write access to the ASI native capability structures of all of the ASI devices in the network, while the other ASI devices are restricted to read-only access, unless granted write permission by the fabric manager.

FIG. 5 is a flow chart showing an example process of initializing fabric management synchronization. Initially, the primary fabric manager (PFM) performs its own discovery/configuration process(es) at 505. This involves the PFM setting various parameters in the switch fabric. For example, the PFM may set a fabric-wide unique Device Serial Number (DSN) and various other parameters, including registers in the Event Capabilities. In an ASI switch fabric, two spanning trees (ST[0] and ST[1]) of the fabric are generated, and a spanning tree owner is elected for each of the spanning trees.

Once PFM discovery/configuration is completed, there is at least one endpoint in the fabric capable of being SFM, and the arbitration process for ST[Y] ownership is run at 505. As used here, X is the index of ST owned by PFM, and Y is the index owned by SFM. The PFM checks whether the ST[Y] Own Field has been set in the PFM at 510. Once the ST[Y] Own Field has been set in the PFM, a synchronization message may be sent from the PFM to the SFM at 515. This message (e.g., PFM_SynchRequest(uint STIndex)), as well as the other messages described below, may form a set of synchronization protocol primitives, such as detailed below in Table 3 for ASI.

TABLE 3
ASI Synchronization Protocol Primitives

| Primitive | Description | |
|---|---|---|
| PFM_SynchRequest(uint STIndex) | PFM requests SFM if it is ready to synchronize. It | |
| | also notifies a newly elected device for SFM that it | |
| | won the arbitration for ST[STIndex] | |
| SFM_SynchRequestReply (uint | SFM responds to PFM whether it is ready or not to | |
| Status) | synchronize and the reason if not. Status of | |
| | SFM_READY indicates success. Otherwise, Status | |
| | is the error code | |
| PFM_SendMsg (uint Task, uint | PFM requests SFM to perform certain tasks or | |
| TaskFlag) | notifies it of an action. TaskFlag identifies task | |
| | related inputs. The task encodings | |
| | as are as follows | |
| | Task | Encoding |
| | GET_TOPOLOGY | 0 |
| | SET_HB_TIMER | 1 |
| | SYNCH_COMPLETE | 2 |
| SFM_SendMsgReply (uint Status) | SFM responds to PFM whether the request was | |
| | fulfilled or not and the reason if not. The Status of | |
| | SUCCESS indicates the request was performed | |
| | successfully. Otherwise, Status is the error code | |
| PFM_SynchTable (uint SyncID, uint | PFM synchronizes the connection-related tables with | |
| Table, uint OpFlag, int Offset, void | SFM. SyncID is the synchronization ID to be | |
| *Data, uint Size) | matched with a response, Table identifies the table | |
| | or the structure being updated, and OpFlag specifies | |
| | one of the three operations REMOVE, ADD, or | |
| | UPDATE to be performed on Table. Offset, Data, | |
| | and Size, specify the offset in the Table, if | |
| | applicable, the new data, and its size in bytes, resp. | |
| | Offset of −1 signifies the entire table is being | |
| | replaced. Table encodings are as follows | |
| | Table | Encoding |
| | HASH | 0 |
| | CONNECTION | 1 |
| | SPANN_TREE | 2 |
| | P2P_CONN | 3 |
| | MCG_MEMBER | 4 |
| | MCG_NODE | 5 |
| | MCG_GROUP | 6 |
| | MC_INGRESS_PORT_PATH | 7 |
| | MC_EGRESS_PORT_PATH | 8 |
| | TPV | 9 |
| SFM_SynchTableReply (int SyncID, | Status sent by SFM in response to | |
| int Status) | PFM_SynchTable. SUCCESS indicates successful | |
| | synchronization. Otherwise, Status is the error code | |
| PFM_SynchGraph (uint SyncID, uint | PFM synchronizes the fabric topology and other | |
| Component, uint OpFlag, void *Data, | fabric graph related updates with SFM. SyncID is | |
| uint Size) | the synchronization ID to be matched with a | |
| | response, Component identifies the graph | |
| | component the update is for, OpFlag specifies one of | |
| | the three operations REMOVE, ADD, or UPDATE | |
| | to be performed on the component, Data is the | |
| | updated data, and Size identifies the size of Data in | |
| | bytes. Component encodings are as follows: | |
| | Component | Encoding |
| | EP | 0 |
| | SW | 1 |
| | LINK | 2 |
| | P2P_PATH | 3 |
| | MC_PATH | 4 |

| | |
|---|---|
| SFM_SynchGrpahReply (int SyncID, | Status sent by SFM in response to |
| int Status) | PFM_SynchGraph. SUCCESS indicates successful |
| | synchronization. Otherwise, Status is the error code |
| PFM_Heartbeat (int Time) | Heartbeat sent from PFM to SFM periodically. The |
| | next heartbeat will arrive in <= Time seconds. Each |
| | time a heartbeat is received SFM will reset its timer. |
| | SFM fail-over can only take place after the 1^{st} |
| | heartbeat is received. The 1^{st} heartbeat is sent only |
| | after all the tables are successfully synchronized |

The SFM receives the synchronization message from the PFM and checks whether the ST[X] Own Field has been set in the SFM at 520. In rare cases, due to propagation delays, PFM has not claimed ownership of SFM (i.e., ST[x] Own Field is not set in SFM yet), but SFM receives the synchronization message. In this case, error handling operations are performed at 525. This may involve just waiting for some time and again checking ST[X] Own Field register. By the time SFM receives the synchronization message, the PFM has been elected, but the ST[X] Own Field register of SFM may not have been set yet (again due to propagation delay).

Once it is established that both PFM and SFM components have been elected in the fabric and the SFM is running and ready to synchronize, the SFM sends a synchronization request reply (e.g., SFM_SynchRequestReply (SFM_READY)) at 530. After receiving this message, the PFM sends a message to the SFM at 535 instructing the SFM to obtain fabric topology (e.g., PFM_SendMsg (GET_TOPOLOGY)). Thus, the SFM waits to obtain the fabric topology from the SFM's perspective until after it is instructed to do so by the PFM.

The SFM obtains its fabric topology at 540. In doing so, the SFM can take advantage of various parameters previously set in the fabric by the PFM. The SFM may use various techniques to obtain the fabric topology. For example, the SFM may use the techniques described in U.S. patent application Ser. No. 10/816,253, filed Mar. 31, 2004, and entitled “ADVANCED SWITCHING FABRIC DISCOVERY PROTOCOL”, which is hereby incorporated by reference.

Once the SFM obtains the fabric topology, the SFM sends a reply message (e.g., SFM_SendMsgReply (SUCCESS)) at 545. Then, the PFM instructs the SFM to synchronize any table and graph elements as needed (note that there may not be any tables yet at this point in the processing, but any tables already set up should be synchronized during the initializing process). For each table and graph element to be synchronized at 550, a synchronization message is sent to the SFM at 555. For example, the PFM_SynchTable ( ) and PFM_SynchGraph ( ) primitives may be used as needed. Each message may identify a specific data structure to be updated and may include a minimum amount of data needed to effect the update. For example, if a table entry needs to be synchronized, the message may include only the data necessary to update that specific table entry within a larger table.

Various data structures may be used by the PFM and SFM. In general, one or more connection-related data structures and one or more fabric-graph-related data structures may be used. In the example from Table 3 above, multiple tables are used to store the connection-related data. The HASH table is used to facilitate fabric topology searching. For example, a hash function may be used along with a hash key to locate a device in the fabric topology. Moreover, using a hash key composed of device address plus port number (turn pool plus turn pointer in ASI) with this hash table can reduce hash table collisions and improve searching operations.

The CONNECTION table from Table 3 above indicates how devices are connected to each other in the switch fabric by detailing the total set of connections in the fabric (multiple links between two devices being treated as one connection for those two devices). The SPANN_TREE table includes information concerning the spanning tree. The P2P_CONN table includes information about the peer-to-peer connections in the fabric (e.g., a list of which devices are involved in peer-to-peer communications). The TPV table is use by third party vendors. The MC_INGRESS_PORT_PATH and MC_EGRESS_PORT_PATH tables includes information about which ingress and egress ports of switches are enabled or disabled for multicast (MC) operations.

The MCG_GROUP table includes information about multicast groups in the switch fabric. The MCG_NODE table includes information about the group (e.g., a newly created group), such as group number, number of members, etc. The MCG_MEMBER table includes information about a member (e.g., a new member that joins a particular multicast group), such as the device serial number, status (listener or writer), etc. These data structures are referred to as tables in its broadest sense, and thus need not be stored as a continuous block of memory.

For example, the data structures used for the MCG_MEMBER and MCG_NODE tables can be as follows:

struct MCGMember
{

| unsigned int | MCGMemDeviceID; | |
|---|---|---|
| MCGStatus | MCGMemStatus; | |
| unsigned int | AccessKey; | //For every writer there can |

// be an access key that is passed to the listeners

| struct MCGMember *Next; | | //Next member in the group |
|---|---|---|
| } | | |
| struct MCGNode | | |
| { | | |
| unsigned short | MCGroupID; | //Multicast Group ID |
| unsigned int | MCGNumMembers; | //# of members in the group |
| int | MCGOwner; | //DeviceID of the owner |
| MCGMemberInfo | *MCGMemberList; | |
| struct MCGNode | *Next; | //Next group node in list |
| } | | |

The MCGNode data structure stores information on a multicast group. A new instance of MCGNode structure may be created when a new multicast group is created, and this structure then contains a pointer to a linked list of member structures. The MCGMember data structure stores information on a member in a multicast group. A new instance of MCGMember structure may be created when a new member joins a particular multicast group, and this structure is used to form the linked list of member structures.

For the fabric-graph-related data structure(s), in the example from Table 3 above, the EP component specifies the endpoints in the switch fabric. The SW component specifies the switches in the switch fabric. The LINK component specifies the links in the switch fabric. All three of these, endpoints, switches and links, may be hot-added or hot-removed (hot-swapped) in the switch fabric.

The P2P_PATH component describes the actual paths being used in the fabric by the devices doing peer-to-peer communications. The MC_PATH component keeps track of the multicast paths for a given group. The fabric-graph-related data structure(s) can be one big data structure that represents the whole fabric graph, where nodes of that big data structure are made up of additional data structures. The big structure may have a common set, and then within the structure, a union of certain data may be unique to endpoints or switches.

As the SFM receives each synchronization message from the PFM, the SFM updates its tables and fabric graph as appropriate at 560 and sends a synchronization reply (e.g., using the SFM_SynchTableReply ( ) and SFM_SynchGrpahReply ( ) primitives) at 565. After the PFM's data structures have been synchronized with the SFM's data structures, the PFM sends one or more messages to complete the synchronization at 570. For example, the PFM may send a PFM_SendMsg (SYNCH_COMPLETE) message and a PFM_SendMsg (SET_HB_TIMER, HB-Period) message.

Various approaches to determining the heartbeat period (HB-Period) are described further below, but in general, the SFM sets a heartbeat timer at 575 in response to one or more messages from the PFM. Then, the SFM may send a reply message (e.g., SFM_SendMsgReply (SUCCESS)) at 580 to indicate that the initializing process has finished.

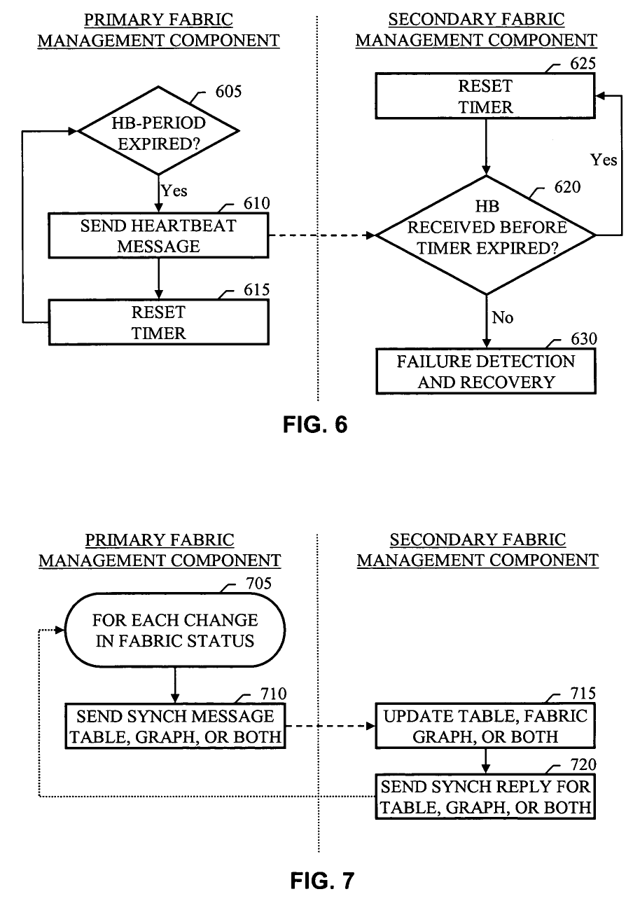

FIG. 6 is a flow chart showing an example process of failover in a fabric management system. The PFM checks for expiration of the HB-Period at 605. Each time the HB-Period expires, the PFM sends a heartbeat message (e.g., PFM_Heartbeat (Time)) at 610 and resets the PFM's timer at 615.

The SFM checks at 620 whether the SFM has received a heartbeat message from the PFM before expiration of the SFM's timer. If so, the SFM's timer is reset at 625. This may involve setting the timer based on time information included in the heartbeat message from the PFM. If the SFM timer expires without the SFM receiving a heartbeat message, the SFM initiates a failure detection and recovery protocol at 630.

Once the SFM detects the PFM has failed, the SFM may take the PFM's role and continue running the fabric without interruption. The new PFM then selects a Fabric Manager capable device, if one exists in the fabric, to become the fabric's new SFM. On the other hand, if the PFM detects the the SFM has failed, the PFM selects a Fabric Manager capable device, if one exists in the fabric, to take the role of the failed SFM while the same PFM continues running the fabric.

This protocol allows for the Fabric Manager devices to detect not only failure of the other, but also isolation from the fabric due to some intermediate hardware failure. The PFM may detect whether the SFM is unable to monitor the PFM, or the PFM is unable to monitor the SFM, or both, due to one or more failed paths that the PFM and SFM were using to monitor each other as opposed to PFM or SFM failing. In this case the PFM may notify the SFM, through some other paths that the PFM is still alive and the SFM should not take the recovery or fail-over actions. Meanwhile, the PFM recovers from the path failure by moving the fabric to a steady and consistent state and reestablishing valid path(s) through which the fabric managers can continue monitoring each other.

FIG. 7 is a flow chart showing an example process of maintaining fabric management synchronization. The PFM maintains its own internal state. For each change in fabric status at 705, the PFM sends one or more synchronization messages at 710. As before, these synchronization messages may be the PFM_SynchTable ( ) and PFM_SynchGraph ( ) primitives. Each message may identify a specific data structure to be updated and may include a minimum amount of data needed to effect the update.

As the SFM receives each synchronization message from the PFM, the SFM updates its tables and fabric graph as appropriate at 715 and sends a synchronization reply (e.g., using the SFM_SynchTableReply ( ) and SFM_SynchGrpahReply ( ) primitives) at 720.

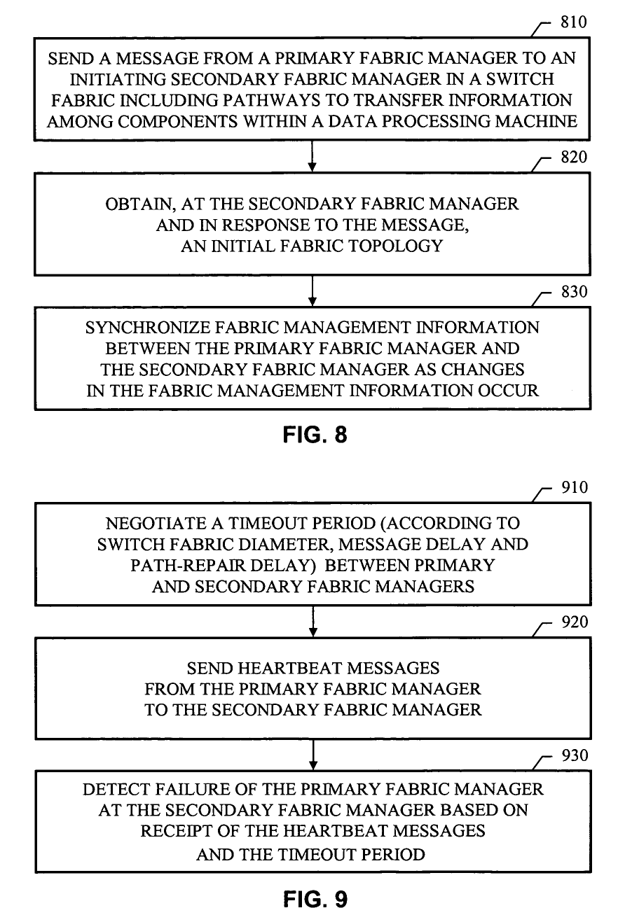

FIG. 8 is a flow chart showing a process of initializing and maintaining fabric management synchronization. A message is sent from a primary fabric manager to an initiating secondary fabric manager in a switch fabric at 810. At the secondary fabric manager, and in response to the message, an initial fabric topology is obtained at 820. Then, fabric management information is synchronized between the primary fabric manager and the secondary fabric manager, at 830, as changes in the fabric management information occur.

Synchronizing the fabric management information may involve synchronizing multicast information and peer-to-peer connections information from the primary fabric manager to the secondary fabric manager, such as described above. Synchronizing the fabric management information may involve sending incremental update messages, specific to the changes in the fabric management information in the primary fabric manager, from the primary fabric manager to the secondary fabric manager. Moreover, sending incremental update messages can involve sending a first type of message to synchronize one or more connection-related data structures and sending a second type of message to synchronize one or more fabric-graph-related data structures.

As a result of this synchronization, if the primary fabric manager fails, the secondary fabric manager is ready to take over running the switch fabric. The primary fabric manager actively sends the critical fabric data to the secondary fabric manager, which is thus ready to handle failover. This can result in improved reliability for the switch fabric, providing a high availability feature for system interconnect.

FIG. 9 is a flow chart showing a process of failover in a fabric management system. A timeout period may be determine by negotiation between the primary and secondary fabric managers at 910. Heartbeat messages may be sent from the primary fabric manager to the secondary fabric manager at 920. Failure of the primary fabric manager may then be detected at the secondary fabric manager based on receipt of the heartbeat messages and the determined timeout period.

The timeout period may be determined according to a diameter of the switch fabric, a per-link message delay and a path-repair delay. The diameter of the switch fabric corresponds to the length of the longest path between two devices in the fabric. The per-link message delay may be an average delay per link, and may thus be combined with the fabric diameter to determine a maximum expected time for a message to go from the primary to the second fabric manager. The path-repair delay may be the average or expected time needed for the primary fabric manager to repair a broken path (e.g., identify that a link is broken and route around that link to repair the path).

The parameters used to set the timeout period may be measured once the switch fabric is up and running. The primary and secondary fabric managers may communicate with each other about these parameters in order to negotiate the timeout period. Moreover, the timeout period used by the primary fabric manager in sending out heartbeat messages need not be the same length of time as the timeout period used by the secondary fabric manager in deciding when the primary fabric manager has failed. In general, the secondary fabric manager should give the primary fabric manager a little more time to send out a heartbeat message. If a link along the path between the primary and secondary fabric managers goes down, resulting in a heartbeat message being lost, the secondary fabric manager may use a timeout period that allows the primary fabric manager the opportunity to identify the broken link, repair the broken path, and resend the heartbeat message. The timeout period may be set using an empirical approach, an analytical approach, or both, based on fabric size, expected traffic, delays, application types, etc.

The systems and techniques presented herein, including all of the functional operations described in this specification, may be implemented in digital electronic circuitry, or in computer hardware, firmware, software, or in combinations of them, such as the structural means disclosed in this specification and structural equivalents thereof. Apparatus according to the described systems and techniques may be implemented as one or more data processing devices communicatively coupled by a switch fabric within a chassis (e.g., multiple motherboards, each having a chipset supporting ASI, plugged into a backplane). Apparatus according to the described systems and techniques may be implemented in a software product (e.g., a computer program product) tangibly embodied in a machine-readable medium (e.g., a magnetic-based storage disk) for execution by a machine (e.g., a programmable processor, network processor, system component); and the processing operations may be performed by a programmable processor executing a program of instructions to perform the described functions by operating on input data and generating output.

The described systems and techniques may be implemented advantageously in one or more software programs that are executable on a programmable system including at least one programmable processor coupled to receive data and instructions from, and to transmit data and instructions to, a data storage system, at least one input device, and at least one output device. Each software program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory, a random access memory and/or a machine-readable signal (e.g., a digital signal received through a network connection).

Generally, a computer will include one or more mass storage devices for storing data files; such devices include magnetic disks, such as internal hard disks and removable disks, magneto-optical disks, and optical disks. Storage devices suitable for tangibly embodying software program instructions and data include all forms of non-volatile memory, including by way of example semiconductor memory devices, such as EPROM (electrically programmable read-only memory), EEPROM (electrically erasable programmable read-only memory), and flash memory devices; magnetic disks such as internal hard disks and removable disks; magneto-optical disks; and optical disks, such as CD-ROM disks. Any of the foregoing may be supplemented by, or incorporated in, ASICs (application-specific integrated circuits).

The present systems and techniques have been described in terms of particular embodiments. Other embodiments are within the scope of the following claims. For example, the operations described may be performed in a different order and still achieve desirable results.

What is claimed is:

1. A machine-implemented method comprising:
sending a message from a primary fabric manager to an initiating secondary fabric manager in a switch fabric comprising pathways configured to transfer information among components within a data processing machine;
obtaining, at the secondary fabric manager and in response to the message, an initial fabric topology; and
synchronizing fabric management information between the primary fabric manager and the secondary fabric manager.

2. The method of claim 1, wherein synchronizing fabric management information comprises synchronizing multicast information and peer-to-peer connections information from the primary fabric manager to the secondary fabric manager.

3. The method of claim 2, wherein the secondary fabric manager is not dedicated to fabric management operations.

4. The method of claim 1, wherein synchronizing fabric management information comprises sending incremental update messages as changes in the fabric management information occur, the messages being specific to the changes in the fabric management information in the primary fabric manager, from the primary fabric manager to the secondary fabric manager.

5. The method of claim 4, wherein sending incremental update messages comprises sending a first type of message to synchronize one or more connection-related data structures and sending a second type of message to synchronize one or more fabric-graph-related data structures.

6. The method of claim 1, further comprising:
sending heartbeat messages from the primary fabric manager to the secondary fabric manager; and
detecting failure of the primary fabric manager at the secondary fabric manager based on receipt of the heartbeat messages and a timeout period determined according to a diameter of the switch fabric, a per-link message delay and a path-repair delay.

7. The method of claim 6, further comprising negotiating between the primary and secondary fabric managers to determine the timeout period.

8. An apparatus comprising a fabric management component configured to cause a primary fabric manager to trigger an initiating secondary fabric manager to obtain an initial fabric topology of a switch fabric comprising pathways configured to transfer information among components within a data processing machine, and the fabric management component configured to synchronize fabric management information between the primary fabric manager and the secondary fabric manager.

9. The apparatus of claim 8, wherein the primary fabric manager is configured to synchronize multicast information and peer-to-peer connections information with the secondary fabric manager.

10. The apparatus of claim 9, wherein the secondary fabric manager is not dedicated to fabric management operations.

11. The apparatus of claim 8, wherein the primary fabric manager is configured to send incremental update messages as changes in the fabric management information occur, the incremental update messages being specific to the changes in the fabric management information in the primary fabric manager, to the secondary fabric manager.

12. The apparatus of claim 11, wherein the incremental update messages comprise a first type of message used to synchronize one or more connection-related data structures and a second type of message used to synchronize one or more fabric-graph-related data structures.

13. The apparatus of claim 8, wherein the primary fabric manager is configured to send heartbeat messages to the secondary fabric manager, and the secondary fabric manager is configured to detect failure of the primary fabric manager based on receipt of the heartbeat messages and a timeout period determined according to a diameter of the switch fabric, a per-link message delay and a path-repair delay.

14. The apparatus of claim 13, wherein the fabric management component is further configured to cause the primary and secondary fabric managers to determine the timeout period through mutual, negotiated agreement.

15. The apparatus of claim 8, wherein the switch fabric conforms to an Advanced Switching Interconnect (ASI) specification defined by an ASI Special Interest Group (SIG).

16. A system comprising:
a network interface device;
a switch fabric comprising pathways configured to transfer information among components within a data processing machine, the components including the network interface device;
a fabric management component configured to cause a primary fabric manager to trigger an initiating secondary fabric manager to obtain an initial fabric topology and configured to synchronize fabric management information between the primary fabric manager and the secondary fabric manager.

17. The system of claim 16, wherein the primary fabric manager is configured to synchronize multicast information and peer-to-peer connections information with the secondary fabric manager.

18. The system of claim 17, wherein the secondary fabric manager is not dedicated to fabric management operations.

19. The system of claim 16, wherein the primary fabric manager is configured to send incremental update messages as changes in the fabric management information occur, the incremental update messages being specific to the changes in the fabric management information in the primary fabric manager, to the secondary fabric manager.

20. The system of claim 19, wherein the incremental update messages comprise a first type of message used to synchronize one or more connection-related data structures and a second type of message used to synchronize one or more fabric-graph-related data structures.

21. The system of claim 16, wherein the primary fabric manager is configured to send heartbeat messages to the secondary fabric manager, and the secondary fabric manager is configured to detect failure of the primary fabric manager based on receipt of the heartbeat messages and a timeout period determined according to a diameter of the switch fabric, a per-link message delay and a path-repair delay.

22. The system of claim 21, wherein the fabric management component is further configured to cause the primary and secondary fabric managers to determine the timeout period through mutual, negotiated agreement.

23. The system of claim 16, wherein the switch fabric conforms to an Advanced Switching Interconnect (ASI) specification defined by an ASI Special Interest Group (SIG).

24. An article comprising a machine-readable medium embodying information indicative of instructions that when performed by one or more machines result in operations comprising:
sending a message from a primary fabric manager to an initiating secondary fabric manager in a switch fabric comprising pathways configured to transfer information among components within a data processing machine, wherein the switch fabric conforms to an Advanced Switching Interconnect (ASI) specification defined by an ASI Special Interest Group (SIG);
obtaining, at the secondary fabric manager and in response to the message, an initial fabric topology; and
synchronizing fabric management information between the primary fabric manager and the secondary fabric manager as changes in the fabric management information occur.

25. The article of claim 24, wherein synchronizing fabric management information comprises synchronizing multicast information and peer-to-peer connections information from the primary fabric manager to the secondary fabric manager.

26. The article of claim 25, wherein the secondary fabric manager is not dedicated to fabric management operations.

27. The article of claim 24, wherein synchronizing fabric management information comprises sending incremental update messages, specific to the changes in the fabric management information in the primary fabric manager, from the primary fabric manager to the secondary fabric manager.

28. The article of claim 27, wherein sending incremental update messages comprises sending a first type of message to synchronize one or more connection-related data structures and sending a second type of message to synchronize one or more fabric-graph-related data structures.

29. The article of claim 24, further comprising:
sending heartbeat messages from the primary fabric manager to the secondary fabric manager; and
detecting failure of the primary fabric manager at the secondary fabric manager based on receipt of the heartbeat messages and a timeout period determined according to a diameter of the switch fabric, a per-link message delay and a path-repair delay.

30. The article of claim 29, further comprising negotiating between the primary and secondary fabric managers to determine the timeout period.
